(19) United States
(12) Patent Application Publication
(10) Pub. No.: US 2026/0131675 A1
(43) Pub. Date: May 14, 2026

(54) Charging Socket for a Motor Vehicle, and Motor Vehicle Equipped Therewith

(71) Applicant: Bayerische Motoren Werke Aktiengesellschaft, Muenchen (DE)

(72) Inventor: Christian MAIER, Eichenau (DE)

(21) Appl. No.: 18/695,651

(22) PCT Filed: Sep. 12, 2022
(86) PCT No.: PCT/EP2022/075204

§ 371 Date: Mar. 26, 2024

(30) Foreign Application Priority Data
Oct. 1, 2021 (DE) 10 2021 125 539.2

(51) Int. Cl. B60L 53/16; H01F 7/18; H01R 13/447

(52) U.S. Cl. CPC B60L 53/16; H01F 7/1872; H01R 13/447; H01R 2201/26

(57) ABSTRACT

A charging socket for a motor vehicle includes a charging socket holder, a first power terminal and a second power terminal which are disposed on the charging socket holder, and a cover where the cover selectively covers at least one of the first power terminal and the second power terminal in a closing position or exposes at least one of the first power terminal and the second power terminal in an opening position. The cover is pivotally mounted on the charging socket holder, is magnetically operatively connected to the charging socket holder, and is configured to execute or interrupt a magnetically induced movement of the cover from the closing position to the opening position and back to the closing position.

### BACKGROUND AND SUMMARY OF THE INVENTION

The present invention relates to a charging socket for a motor vehicle and to a motor vehicle equipped therewith.

A charging socket for an electrically operable motor vehicle is known from DE 10 2020 201 574A 1 , wherein a first power terminal and a second power terminal are provided on a charging socket holder. The charging socket as a whole can be optionally covered or exposed by means of an electric motor-driven charging socket cover. A covering means is further provided, which optionally covers or exposes one of the two power terminals. The charging socket cover and the covering means are positively connected by means of a mechanism, particularly comprising a series of springs such that, in each case, a manual initiation of a movement of the covering means is required. It is apparent that, overall, this known charging socket assumes a complex design.

The object of the present invention is the elimination of the above-mentioned disadvantage in a charging socket or in a correspondingly equipped motor vehicle.

Specifically, the above-mentioned object is fulfilled by a charging socket for a motor vehicle, which is provided with a first power terminal and a second power terminal, which are arranged on a charging socket holder, and with a covering means for selectively covering one of the two power terminals, in a closing position, or for exposing same in an opening position. The power socket is characterized in that the covering means is pivotally mounted on the charging socket holder, is magnetically operatively connected thereto, and is designed to execute or interrupt a magnetically induced movement of the covering means from the closing position to the opening position and back. In other words, the covering means is configured in a magnetically or electromagnetically openable or closable arrangement by means of a power terminal, without the necessity for a mechanically operative connection thereof to a charging socket cover. Consequently, if the covering means is located in the region of the first power terminal, the first power terminal is configured such that it is optionally covered or exposed by the covering means. If the covering means is located in the region of the second power terminal, the second power terminal is configured such that it is optionally covered or exposed by the covering means. It is understood that the respectively corresponding components, according to their functional position, can be configured or set to be mutually magnetically attractive or repellent. In an advantageous manner, a cost-effectively producible and reliably functioning device is thus provided which, moreover, is of a comparatively simple design.

It is further understood that, with respect to a magnetic connection, any appropriate material or any appropriate material combination can be preferred. The respectively provided magnet or the respectively provided magnetic material is configured in the form of a soft magnetic material, particularly an iron-, nickel-or cobalt-based alloy, or as a soft ferrite material (NiZn, MnZn), or as a hard magnetic material, particularly NdFeB, or an AINiCo alloy.

According to a preferred embodiment, a pivoting axis of the covering means is at least partially mounted on, and/or a magnetic closing means is at least partially accommodated in the charging socket holder. In an advantageous manner, the reliability and cost-effective production of the device according to the invention are further improved as a result. In particular, the magnetic closing means can be arranged in the charging socket holder and, in a particularly preferred manner, in a common housing with the power terminals, as a result of which a compact charging socket is provided.

The reliability and cost-effective production of the charging socket according to the invention are further improved if the magnetic closing means is configured in the form of an electromagnet and is operatively connected to at least one section of the covering means and/or of the pivoting axis, which is configured in the form of a magnet and/or which comprises a magnetic component. In other words, the charging socket according to the invention is designed such that, by means of a variation in the magnetic field generated by the magnetic closing means or the electromagnet, a movement of the pivoting axis and/or of the covering means is initiated, executed or terminated.

According to a further preferred embodiment, it is provided that the magnetic closing means is operatively connected to a circuit board or card which is located in the charging socket. Accordingly, an electronic or electrical actuation of the magnetic closing means, particularly of the electromagnet, is permitted by means of electronics which are present in the charging socket in any event and which, in particular, are operatively connected to the on-board electronics of a motor vehicle, thereby advantageously reducing the complexity of manufacture and the complexity of installation of the charging socket in a motor vehicle.

According to an additional preferred embodiment, it is provided that, on the charging socket holder, in the region of the end of the covering means which is arranged opposite the pivoting axis, an electromagnet which is operatively connected thereto is located, which is designed to magnetically repel the covering means for the initiation of an opening position and/or to magnetically attract the covering means for the establishment of a closing position. As a result, the opening motion and closing motion, or the maintenance of the closing position, are additionally electromechanically supported, in an advantageous manner. It is understood that the electromagnet can optionally be operatively connected to the circuit board which is located in the charging socket, such that the complexity of manufacture and the complexity of installation of the charging socket according to the invention are further reduced in an advantageous manner, and the actuation thereof is facilitated in a simple manner.

The above-mentioned object is also fulfilled by a motor vehicle having a least one charging socket of the type disclosed above. The advantages thereof described apply correspondingly.

A detailed, non-prejudicial and, in particular, limited description of exemplary embodiments of the present invention is provided hereinafter, with reference to the attached figures, which are not represented to scale.

### BRIEF DESCRIPTION OF THE DRAWINGS

FIG. 1 shows a perspective view of a charging socket according to the invention, having a covering means which is located in a closing position;

FIG. 2 shows part of the charging socket represented according to FIG. 1, in a lateral cross-sectional view;

FIG. 3 shows the charging socket represented according to FIG. 2, in an opening position;

FIG. 4 shows an alternative embodiment of a charging socket, in a representation according to FIG. 2.

### DETAILED DESCRIPTION OF THE DRAWINGS

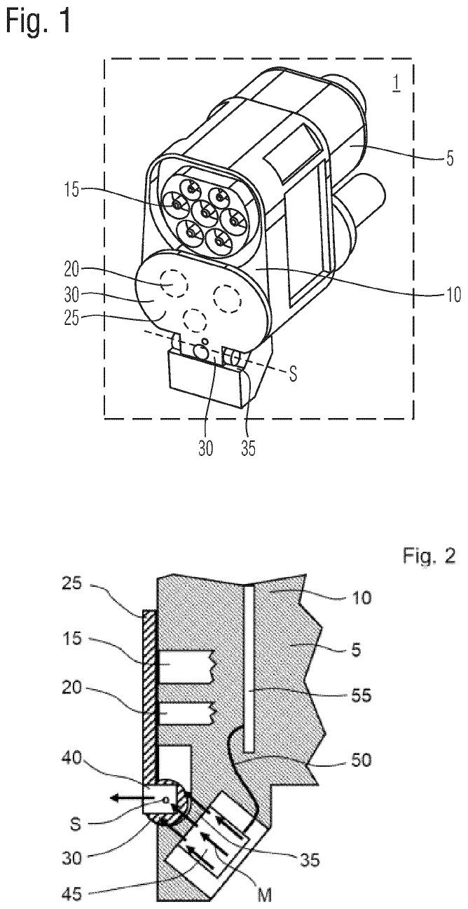

FIG. 1 shows part of a symbolically illustrated motor vehicle 1 according to the invention, in which a charging socket 5 is installed. The charging socket 5 comprises a charging socket holder 10, in which a first power terminal 15 and a second power terminal 20, which is arranged thereunder, are provided. The second power terminal 20 is covered by a covering means 25 which is located in a closing position, such that the second power terminal 20 illustrated in this figure is represented in a symbolic manner only. The first power terminal 15 or the second power terminal 20 can be embodied in any appropriate manner. The first power terminal 15, for example, can thus be configured in the form of a DC terminal which is known per se, whereas the second power terminal 20 can be configured in the form of an AC terminal.

The covering means 25 is essentially configured with a plate-shaped design and, in the closing position represented, is arranged such that the surface thereof facing the charging socket 5 engages with the charging socket holder 10. At one end, the covering means 25 is rotatably mounted about a pivoting axis S, as can be particularly clearly seen in FIG. 2. The latter shows part of the charging socket holder 10 represented in FIG. 1, in a lateral cross-sectional view wherein, in the interests of simplicity, any illustration of the vehicle 1, and of details of the first power terminal 15, or of the second power terminal 20, have been omitted.

For the purposes of pivoting, that part of the covering means 25 which is located about the pivoting axis S is provided with a rounded section 30, which is rotatably mounted in a corresponding section 35 of the charging socket holder 10. Moreover, a magnetic means 40, which is configured in the form of a permanent magnet, is located in the rounded section 30, which is electromagnetically operatively connected to a magnetic closing means 45, which is configured in the form of an electromagnet and is located in the charging socket holder 10. The electromagnetic operative connection is symbolized by arrows M which are representative of selected field lines. By means of an electrical conductor 50, the magnetic closing means 45 is connected to a circuit board or card 55 which is located in the charging socket 5, such that an initiation of a movement of the covering means 25, the direction of movement of the covering means 25, the speed of movement of the covering means 25 and/or a termination of the movement of the covering means 25 can be controlled or regulated. According to the exemplary embodiment represented here, the circuit board 55 is operatively connected to on-board electronics of the motor vehicle 1, which are not represented here.

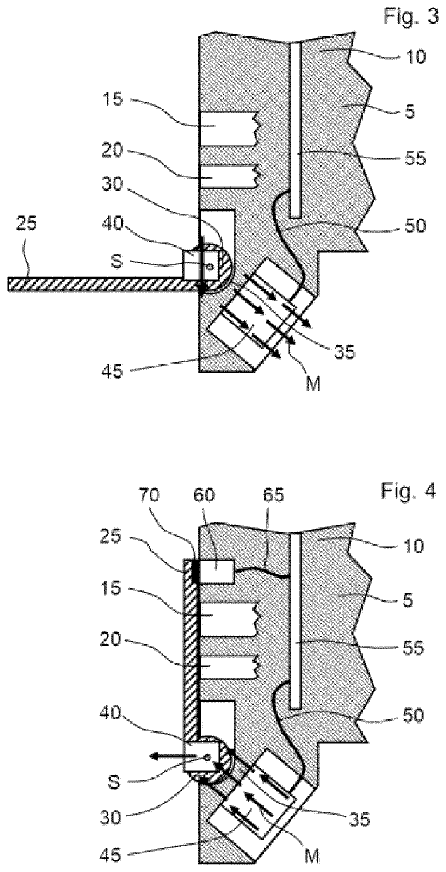

The setting of the covering means 25 in the fully opened position is thus illustrated in FIG. 3. As can be seen, the arrows M which are representative of selected field lines assume a different orientation to that represented in the covering setting according to FIG. 2. In other words, commencing from the state represented in FIG. 2, energization of the magnetic means 40 by the magnetic closing means 45 has been executed, such that a movement of the magnetic means 40 about the pivoting axis S, and thus a movement of the covering means 25, has been generated.

The embodiment of a charging socket 5 represented in FIGS. 2 and 3, in principle, permits a reliable movement of the covering means 25 or the maintenance thereof in a desired position, i.e., a closing position, an opening position, or any arbitrary position therebetween. According to the alternative embodiment represented in FIG. 4, additionally, at an opposing end of the covering means 25 to the pivoting axis S and located in charging socket cover 10, an electromagnet 60 can be provided, which is connected to the circuit board 55 by means of an electrical conductor 65. The electromagnet 60 is energized with current such that it attracts an, in particular ferromagnetic section 70 of the covering means 25 which is distant from the pivoting axis S into the closing position represented. Conversely, if the opening of the covering means 25 is required, the electromagnet 60 is energized such that it repels the ferromagnetic section 70 (not represented).

It should be observed that the movement or interruption of a movement of the covering means 25 according to the invention is initiated by an electromagnetic operative connection between the magnetic means 40 and the magnetic closing means 45, optionally supported by an electromagnetic operative connection of the electromagnet 60 to the magnetic section 70. However, although this is not represented in FIGS. 1 to 4, additional mechanical spring means can be provided, in order to support a desired movement of the covering means 25. Thus, on the charging socket holder 10, in the region of the section 35, a torsion spring can be arranged, which is operatively connected to the section 30: where the covering means 25 is magnetically moved from the opening position to the closing position, the torsional spring is tensioned. Accordingly, the movement of the covering means 25 for the desired assumption of the closing position is supported by a spring force.

### LIST OF REFERENCE CHARACTERS

1 Motor vehicle
5 Charging socket
10 Charging socket holder
15 First power terminal
20 Second power terminal
25 Covering means
30 Rounded section
35 Corresponding section
40 Magnetic means
45 Magnetic closing means
50 Electrical conductor
55 Circuit board
60 Electromagnet
65 Electrical conductor
70 Magnetic section
M Operative connection
S Pivoting axis

1.-6. (canceled)

7. A charging socket for a motor vehicle, comprising:
a charging socket holder;
a first power terminal and a second power terminal which are disposed on the charging socket holder; and
a covering means, wherein the covering means selectively covers at least one of the first power terminal and the second power terminal in a closing position or exposes at least one of the first power terminal and the second power terminal in an opening position;
wherein the covering means is pivotally mounted on the charging socket holder, is magnetically operatively connected to the charging socket holder, and is configured to execute or interrupt a magnetically induced movement of the covering means from the closing position to the opening position and back to the closing position.

8. The charging socket according to claim 7, wherein a pivoting axis of the covering means is at least partially mounted on the charging socket holder and/or a magnetic closing means is at least partially accommodated in the charging socket holder.

9. The charging socket according to claim 8, wherein the magnetic closing means is an electromagnet and is operatively connected to at least one section of the covering means and/or of the pivoting axis and wherein the covering means is a magnet or a magnetic component.

10. The charging socket according to claim 8, wherein the magnetic closing means is operatively connected to a circuit board which is disposed in the charging socket.

11. The charging socket according to claim 8, wherein an electromagnet is disposed on the charging socket holder in a region of an end of the covering means which is disposed opposite the pivoting axis and wherein the electromagnet magnetically repels the covering means for initiation of the opening position and magnetically attracts the covering means for establishment of the closing position.

12. A motor vehicle, comprising:
the charging socket according to claim 7.
